(19) United States
(12) Patent Application Publication
(10) Pub. No.: US 2016/0142000 A1
(43) Pub. Date: May 19, 2016

(54) MOTOR VEHICLE

(71) Applicant: Toyota Jidosha Kabushiki Kaisha, Toyota-shi Aichi-ken (JP)

(72) Inventors: Tomoko Oba, Nagoya-shi Aichi-ken (JP); Akihiko Ide, Miyoshi-shi (JP); Hiroshi Ukegawa, Nisshin-shi (JP)

(21) Appl. No.: 14/944,819

(22) Filed: Nov. 18, 2015

(30) Foreign Application Priority Data
Nov. 18, 2014 (JP) 2014-233437

(51) Int. Cl. H02P 29/02; B60L 11/12; B60L 11/08; H02P 6/00

(52) U.S. Cl. CPC H02P 29/021; H02P 6/001; B60L 11/12; B60L 11/08

(57) ABSTRACT

In the case where an on-fixation failure occurs in one of transistors of an inverter, a shutdown signal GSDWN or MSDWN is output as ON signal for a duration of adjusting time since switching of a fail signal GFINV or MFINV to ON signal. After elapse of the adjustment time, the shutdown signal GSDWN or MSDWN is switched to OFF signal. The adjustment time is set to be longer than a time duration until completion of shutdown of the inverter but to be shorter than a time duration until start of emergency drive control. This allows for cancellation of shutdown of the inverter even when an abnormal signal is continuously output due to a failure of a sensor or the like. This causes emergency drive to be more reliably performed with three-phase on-control including a transistor having an on-fixation failure after shutdown of the inverter.

This application claims priority to Japanese Patent Application No. 2014-233437 filed 18 Nov. 2014, the contents of which is incorporated herein by reference.

### TECHNICAL FIELD

The present invention relates to a motor vehicle and more specifically relates to a motor vehicle equipped with a power source that is configured to output power to an axle and a motor that is mechanically linked with the axle.

### BACKGROUND ART

With regard to a hybrid vehicle configured such that an engine and two motors are connected by a planetary gear, a proposed technique performs three-phase on-control including a short-circuit phase when an inverter for driving the two motors has a one-phase short-circuit fault (for example, JP 2009-195026A). This hybrid vehicle estimates the short-circuit phase based on the circulating current generated due to the one-phase short-circuit fault of the inverter and performs emergency drive with three-phase on-control including the estimated short-circuit phase.

### CITATION LIST

### Patent Literature

Patent Document 1: Japanese Patent Laid-Open No. JP 2009-195026A

### SUMMARY OF INVENTION

### Technical Problem

In a motor vehicle equipped with a motor for driving, such as the hybrid vehicle described above, in the event of an abnormality in an element of the inverter for driving the motor, control is often performed to shut down the inverter and stop the vehicle. A configuration having a self-protection circuit that outputs an abnormal signal in response to detection of an overheat state by a thermosensor or overcurrent by a current sensor, is often employed for the elements of the inverter. When the thermosensor has an abnormality by overheat, the thermosensor continuously outputs a signal representing the overheat state, so that the self-protection circuit continuously outputs an abnormal signal. Continuously outputting the abnormal signal results in keeping the shutdown of the inverter and thereby causes neither estimation of the short-circuit phase nor three-phase on-control to be performed.

With regard to the motor vehicle, an object of the invention is to cancel shutdown of an inverter even when an abnormal signal is continuously output due to a failure of a sensor or the like.

### Solution to Problem

In order to solve at least part of the problems described above, the motor vehicle of the invention may be implemented by the following aspects or configurations.

According to one aspect of the invention, there is provided a motor vehicle including: a power source that is configured to output power to an axle; a motor that is mechanically linked with the axle; an inverter that is configured to have a plurality of switching elements and drive the motor; an abnormal signal generator that is configured to switch an abnormal signal on in the case where a fault occurs in any of the plurality of switching elements; a shutdown controller that is configured to shut down the inverter when a shutdown abnormal signal is switched on, based on switching the abnormal signal on; and an abnormal signal conditioner that is configured to, in response to switching the abnormal signal on, keep the shutdown abnormal signal on for a predetermined time period and subsequently switch the shutdown abnormal signal off, irrespective of a time duration when the abnormal signal is kept on.

In the motor vehicle according to the above aspect, when the abnormal signal is switched on, irrespective of the subsequent time duration when the abnormal signal is kept on, the shutdown abnormal signal for shutting down the inverter is kept on for the predetermined time period and is then switched off. This causes the inverter to be shut down, while causing the shutdown to be cancelled during subsequent emergency drive control or the like and allowing for switching control of normal switching elements other than a switching element having a fault among he plurality of switching elements. For example, in the case where an on-fixation failure occurs in one of the plurality of switching elements, the emergency drive control is activated to estimate a switching element having an on-fixation failure based on the circulating current generated due to the on-fixation failure of the switching element and perform emergency drive with three-phase on-control that switches on the three-phase switching elements including the estimated switching elements.

### BRIEF DESCRIPTION OF DRAWINGS

FIG. 1 is a configuration diagram illustrating the schematic configuration of a hybrid vehicle according to one embodiment of the invention;

FIG. 2 is a configuration diagram illustrating the schematic configuration of an electrical system including motors MG1 and MG2;

FIG. 3 is a diagram illustrating one example of a transistor configured as intelligent power module;

FIG. 4 is a configuration diagram illustrating one exemplary configuration of an abnormal signal conditioning circuit;

FIG. 5A is a diagram illustrating one example of time changes when a temperature of a thermosensor Sth exceeds a threshold value for a short time duration, a fail signal MFINV, a signal from a latch circuit ML, a signal from an inversion circuit MINV, a shutdown signal MSDWN and a conventional shutdown signal MSDWN;

FIG. 5B is a diagram illustrating one example of time changes when a thermosensor Sth is broken and a temperature output continuously exceeds a threshold value, a fail signal MFINV, a signal from a latch circuit ML, a signal from an inversion circuit MINV, a shutdown signal MSDWN and a conventional shutdown signal MSDWN;

FIG. 6 is a configuration diagram illustrating one exemplary configuration of a prior art abnormal signal conditioning circuit;

FIG. 7 is a configuration diagram illustrating the schematic configuration of a hybrid vehicle according to one modification; and

FIG. 8 is a configuration diagram illustrating the schematic configuration of a hybrid vehicle according to another modification.

### DESCRIPTION OF EMBODIMENTS

The following describes some aspects of the invention with reference to embodiments.

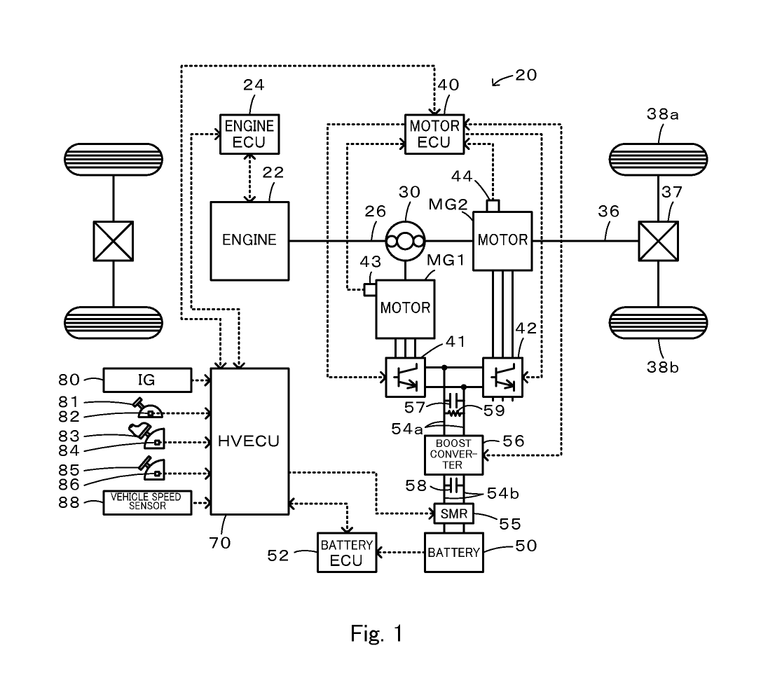

FIG. 1 is a configuration diagram illustrating the schematic configuration of a hybrid vehicle 20 according to one embodiment of the invention. As illustrated, the hybrid vehicle 20 of this embodiment includes an engine 22, an engine electronic control unit (hereinafter referred to as engine ECU) 24, a planetary gear 30, a motor MG1, a motor MG2, inverters 41 and 42, a motor electronic control unit (hereinafter referred to as motor ECU) 40, a battery 50, a battery electronic control unit (hereinafter referred to as battery ECU) 52, a boost converter 56 and a hybrid electronic control unit (hereinafter referred to as HVECU) 70.

The engine 22 is configured as a general internal combustion engine that outputs power using gasoline, light oil or the like as fuel and is driven and controlled by the engine ECU 24. The engine ECU 24 is implemented by a CPU-based microprocessor and includes a ROM that stores processing programs, a RAM that temporarily stores data, input and output ports and a communication port other than the CPU, although not being illustrated. The engine ECU 24 inputs, via its input port, signals from various sensors provided to detect the operating conditions of the engine 22. The signals input via the input port include a crank position θcr from a crank position sensor configured to detect the rotational position of a crankshaft 26, a cooling water temperature Twe from a water temperature sensor configured to detect the temperature of cooling water of the engine 22, a cam position θca from a cam position sensor configured to detect the rotational position of a cam shaft provided to open and close an intake valve or an exhaust valve, a throttle position TP from a throttle valve position sensor configured to detect the position of a throttle valve, an intake air flow Qa from an air flow meter mounted to an intake pipe, and an intake air temperature Ta from a temperature sensor also mounted to the intake pipe. The engine ECU 24 outputs, via its output port, various control signals for driving the engine 22. The control signals output via the output port include a drive signal to a fuel injection valve, a drive signal to a throttle motor configured to adjust the position of the throttle valve and a control signal to an ignition coil integrated with an igniter. The engine ECU 24 communicates with the HVECU 70 to perform operation control of the engine 22 in response to control signals from the HVECU 70 and output data regarding the operating conditions of the engine 22 to the HVECU 70 as appropriate. The engine ECU 24 computes the rotation speed of the crankshaft 26, which is equal to a rotation speed Ne of the engine 22, based on the signal from the crank position sensor (not shown) mounted to the crankshaft 26.

The planetary gear 30 is configured as a single pinion-type planetary gear mechanism. The planetary gear 30 includes a sun gear, a ring gear and a carrier, which are respectively connected with a rotor of the motor MG1, a driveshaft 36 linked with drive wheels 38a and 38b via a differential gear 37, and the crankshaft 26 of the engine 22.

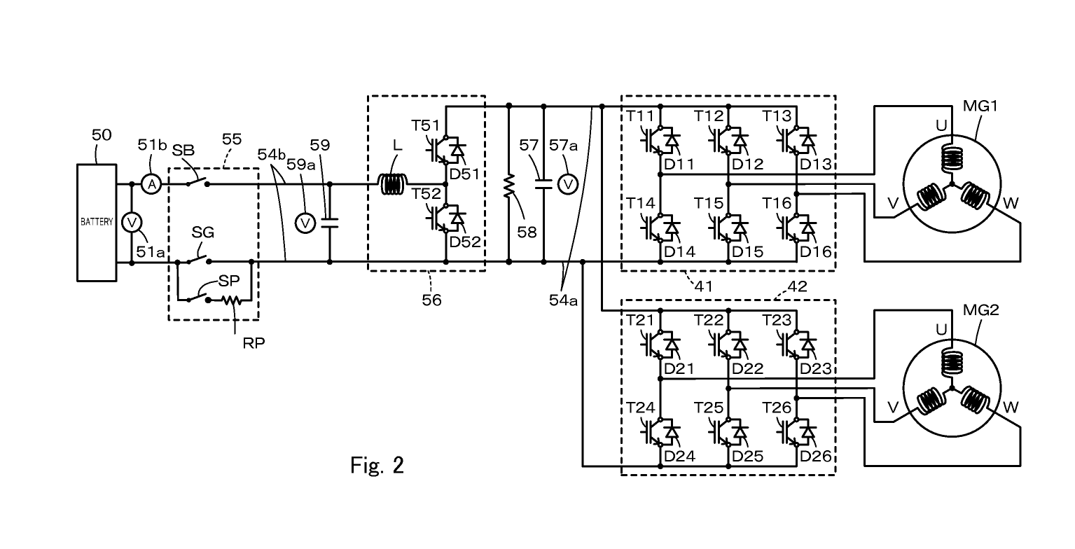

The motor MG1 is configured as a known synchronous motor generator including a rotor with permanent magnets embedded therein and a stator with three-phase coils wound thereon. The rotor is connected with the sun gear of the planetary gear 30 as described above. The motor MG2 is also configured as a synchronous motor generator like the motor MG1 and has a rotor connected with the driveshaft 36. The motor ECU 40 controls the inverters 41 and 42 to drive the motors MG1 and MG2. The inverters 41 and 42 are connected with the boost converter 56 by power lines (hereinafter referred to as driving-voltage system power lines) 54a. The boost converter 56 is connected with the battery 50 and a system main relay 55 by power lines (hereinafter referred to as battery-voltage system power lines) 54b. As shown in FIG. 2, each of the inverters 41 and 42 is comprised of six transistors T11 to T16 or T21 to T26 and six diodes D11 to D16 or D21 to D26 which are connected reversely in parallel to the transistors T11 to T16 or T21 to T26. The transistors T11 to T16 or T21 to T26 are arranged in pairs as the source and the sink relative to a positive bus bar and a negative bus bar of the driving-voltage system power lines 54a. The three-phase coils (U phase, Vphase and W phase) of the motor MG1 or MG2 are respectively connected with respective junction points of the three paired transistors. Accordingly, regulating the ratio of the on time of the respective paired transistors in the transistors T11 to T16 or T21 to T26 under application of a voltage to the inverter 41 or 42 forms a rotating magnetic field in the three-phase coils to rotate and drive the motor MG1 or MG2. The inverters 41 and 42 share the positive bus bar and the negative bus bar of the driving-voltage system power lines 54a, so that electric power generated by one of the motors MG1 and MG2 is supplied to the other motor.

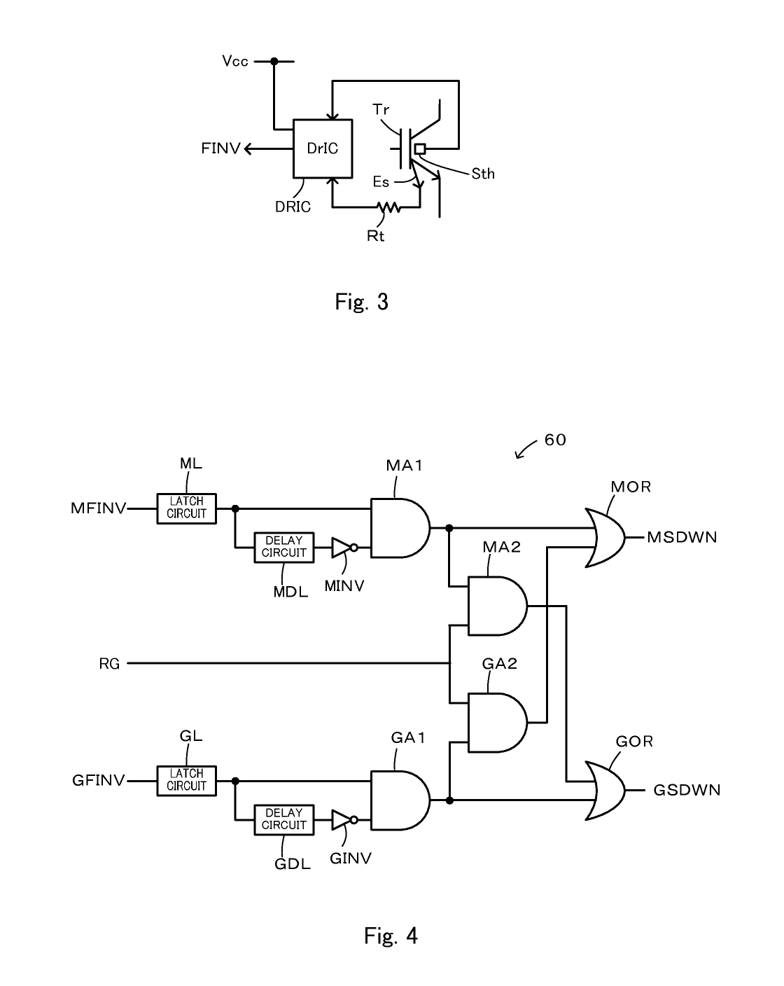

Each of the transistors T11 to T16 of the inverter 41 and the transistors T21 to T26 of the inverter 42 is configured as an intelligent power module (IPM) as illustrated in FIG. 3.

Each of the transistors T11 to T16 and T21 to T26 is shown as transistor Tr in FIG. 3. In the description below, the transistor Tr represents each of the transistors T11 to T16 and T21 to T26. The transistor Tr may be, for example, an insulated gate bipolar transistor (IGBT), and a drive circuit DRIC is mounted to the transistor Tr. As illustrated, in the transistor Tr, an overcurrent detection element Es adjusted for the flow of a predetermined ratio of electric current that is 1/2000 to 1/6000 of the electric current flowing through an emitter is mounted to the emitter. This overcurrent detection element Es is connected with the drive circuit DRIC via a resistor Rt for overcurrent detection. A thermosensor Sth for detecting the temperature of the transistor Tr is also mounted to the transistor Tr and is connected with the drive circuit DRIC. The drive circuit DRIC is configured as a semiconductor integrated circuit to output a fail signal FINV as ON signal when the value of a signal from the overcurrent detection element Es exceeds a predetermined threshold value for detection of overcurrent or when the value of a signal from the thermosensor Sth exceeds a predefined threshold value for detection of overheat. The fail signals FINV from the respective transistors T11 to T16 of the inverter 41 are input into an OR gate (not shown), and a fail signal GFINV as their logical sum of the respective fail signals FINV is output from the OR gate. Similarly, the fail signals FINV from the respective transistors T21 to T26 of the inverter 42 are input into an OR gate (not shown), and a fail signal MFINV as their logical sum of the respective fail signals FINV is output from the OR gate. Accordingly, in the event of a failure in any of the transistors T11 to T16 of the inverter 41 for driving the motor MG1, the fail signal GFINV is output as ON signal. In the event of a failure in any of the transistors T21 to T26 of the inverter 42 for driving the motor MG2, the fail signal MFINV is output as ON signal.

The fail signals GFINV and MFINV are input into an abnormal signal conditioning circuit 60 illustrated in FIG. 4. The abnormal signal conditioning circuit 60 includes the following circuits: latch circuits GL and ML configured to retain the ON outputs of the fail signals GFINV and MFINV for a predetermined retention time; delay circuits GDL and MDL configured to delay the output of signals from the latch circuits GL and ML by a predetermined delay time; inversion circuits GINV and MINV configured to invert signals from the delay circuits GDL and MDL; AND gates GA1 and MA1 configured to input signals from the latch circuits GL and ML and signals from the inversion circuits GINV and MINV and output their logical products; AND gates GA2 and MA2 configured to input an RG signal that has normally ON output but has OFF output as appropriate by the motor ECU 40 and signals from the AND gates GA1 and MA1 and output their logical products; an OR gate GOR configured to input a signal from the AND gate GA1 and a signal from the AND gate MA2 and output a shutdown signal GSDWN as their logical sum; and an OR gate MOR configured to input a signal from the AND gate MA1 and a signal from the AND gate GA2 and output a shutdown signal MSDWN as their logical sum. The shutdown signals GSDWN and MSDWN from the OR gates GOR and MOR of the abnormal signal conditioning circuit 60 are input into the motor ECU 40. This embodiment is designed such that the predetermined retention time of the ON signals in the latch circuits GL and ML is identical with the predetermined delay time in the delay circuits GDL and MDL (hereinafter this identical time is called “adjustment time”).

As shown in FIG. 2, the boost converter 56 is configured to include two transistors T51 and T52, two diodes D51 and D52 connected reversely in parallel to the transistors T51 and T52 and a reactor L. The two transistors T51 and T52 are respectively connected with the positive bus bar of the driving-voltage system power lines 54a and with the negative bus bars of the driving-voltage system power lines 54a and the battery-voltage system power lines 54b. The reactor L is connected with a junction point of the transistors T51 and T52 and with the positive bus bar of the battery-voltage system power line 54b. The transistors T51 and T52 are accordingly controlled on and off to boost the electric power of the battery-voltage system power lines 54b and supply the boosted electric power to the driving-voltage system power lines 54a, while stepping down the electric power of the driving-voltage system power lines 54a and supplying the stepped-down electric power to the battery-voltage system power lines 54b.

A smoothing capacitor 57 for smoothing and a discharge resistor 58 for discharging are connected in parallel with the driving-voltage system power lines 54a. The system main relay 55 comprised of a positive relay SB, a negative relay SG, a precharge relay SP and a precharge resistor RP is mounted to an output terminal of the battery 50 in the battery-voltage system power lines 54. Additionally, a filter capacitor 59 for smoothing is connected with a boost converter 56-side of the battery-voltage system power lines 54b.

The motor ECU 40 is implemented by a CPU-based microprocessor and includes a ROM that stores processing programs, a RAM that temporarily stores data, input and output ports and a communication port other than the CPU, although not being illustrated. The motor ECU 40 inputs, via its input port, signals required for drive control of the motors MG1 and MG2.

The signals input via the input port include rotational positions θm1 and θm2 from rotational position detection sensors 43 and 44 configured to detect the rotational positions of the rotors of the motors MG1 and MG2, motor temperatures Tmg from temperature sensors (not shown) mounted to the motors MG1 and MG2, phase currents to be applied to the motors MG1 and MG2 detected by current sensors (not shown), a voltage VH (voltage of the driving-voltage system power lines 54a, hereinafter referred to as driving-voltage system voltage) of the smoothing capacitor 57 from a voltage sensor 57a located between terminals of the smoothing capacitor 57, a voltage VL (voltage of the battery-voltage system power lines 54b, hereinafter referred to as battery-voltage system voltage) of the filter capacitor 59 from a voltage sensor 59a located between terminals of the filter capacitor 59, and the shutdown signals GSDWN and MSDWN from the abnormal signal conditioning circuit 60. The motor ECU 40 outputs, via its output port, control signals for driving the inverters 41 and 42 and the boost converter 56. The control signals output via the output port include switching control signals to the transistors T11 to T16 and T21 to T26 of the inverters 41 and 42, switching control signals to the transistors T51 and T52 of the boost converter 56 and the RG signal that has normally ON output but has OFF output as appropriate to the abnormal signal conditioning circuit 60. The motor ECU 40 communicates with the HVECU 70 to perform drive control of the motors MG1 and MG2 in response to control signals from the HVECU 70 and output data regarding the operating conditions of the motors MG1 and MG2 to the HVECU 70 as appropriate. The motor ECU 40 computes rotation speeds Nm1 and Nm2 of the motors MG1 and MG2 based on the rotational positions θm1 and θm2 of the rotors of the motors MG1 and MG2 from the rotational position detection sensors 43 and 44.

The battery 50 is configured, for example, as a lithium ion secondary battery to transmit electric power to and from the motors MG1 and MG2 via the inverters 41 and 42. The battery ECU 52 configured to manage the battery 50 is implemented by a CPU-based microprocessor and includes a ROM that stores processing programs, a RAM that temporarily stores data, input and output ports and a communication port other than the CPU, although not being illustrated. The battery ECU 52 inputs, via its input port, signals required for management of the battery 50 and sends data regarding the conditions of the battery 50 as appropriate to the HVECU 70 by communication. The signals input via the input port include a battery voltage Vb from a voltage sensor 51a located between terminals of the battery 50, a battery current Ib from a current sensor 51b mounted to a power line connected with an output terminal of the battery 50, and a battery temperature Tb from a temperature sensor (not shown) mounted to the battery 50. With a view to managing the battery 50, the battery ECU 52 computes a state of charge SOC which denotes a ratio of the capacity of electric power dischargeable from the battery to the entire capacity, based on an integrated value of the charge-discharge current Ib detected by the current sensor 51b, and computes input and output limits Win and Wout which denote maximum allowable electric powers chargeable into and dischargeable from the battery 50, based on the computed state of charge SOC and the battery temperature Tb.

The HVECU 70 is implemented by a CPU-based microprocessor and includes a ROM that stores processing programs, a RAM that temporarily stores data, input and output ports and a communication port other than the CPU, although not being illustrated. The HVECU 70 inputs, via its input port, various signals required for drive control. The signals input via the input port include an ignition signal from an ignition switch 80, a shift position SP from a shift position sensor 82 configured to detect the operational position of a shift lever 81, an accelerator position Acc from an accelerator pedal position sensor 84 configured to detect the depression amount of an accelerator pedal 83, a brake pedal position BP from a brake pedal position sensor 86 configured to detect the depression amount of a brake pedal 85, and a vehicle speed V from a vehicle speed sensor 88. The HVECU 70 outputs, via its output port, control signals including a drive signal to the system main relay 55. As described above, the HVECU 70 is connected with the engine ECU 24, the motor ECU 40 and the battery ECU 52 via the communication ports to transmit various control signals and data to and from the engine ECU 24, the motor ECU 40 and the battery ECU 52.

The hybrid vehicle 20 of the embodiment having the above configuration calculates a required torque to be output to the driveshaft 36, based on the vehicle speed V and the accelerator position Acc corresponding to the driver's depression amount of the accelerator pedal 83, and performs operation control of the engine 22, the motor MG1 and the motor MG2 such as to cause a required power corresponding to the calculated required torque to be output to the driveshaft 36. The operation control of the engine 22, the motor MG1 and the motor MG2 has the following three modes (1) to (3):

(1) torque conversion operation mode: operation mode that performs operation control of the engine 22 such as to cause a power satisfying the required power to be output from the engine 22 and performs drive control of the motor MG1 and the motor MG2 such that all the power output from the engine 22 is subjected to torque conversion by the planetary gear 30, the motor MG1 and the motor MG2 and is output to the driveshaft 36;
(2) charge-discharge operation mode: operation mode that performs operation control of the engine 22 such as to cause a power satisfying a sum of the required power and electric power required to charge the battery 50 or electric power to be discharged from the battery 50, to be output from the engine 22 and performs drive control of the motor MG1 and MG2 such that all the power or part of the power output from the engine 22 with charging or discharging the battery 50 is subjected to torque conversion by the planetary gear 30, the motor MG1 and the motor MG2 and thereby the required power is output to the driveshaft 36; and
(3) motor operation mode: operation mode that performs operation control such as to cause a power satisfying the required power to be output from the motor MG2 to the driveshaft 36 with operation stop of the engine 22.

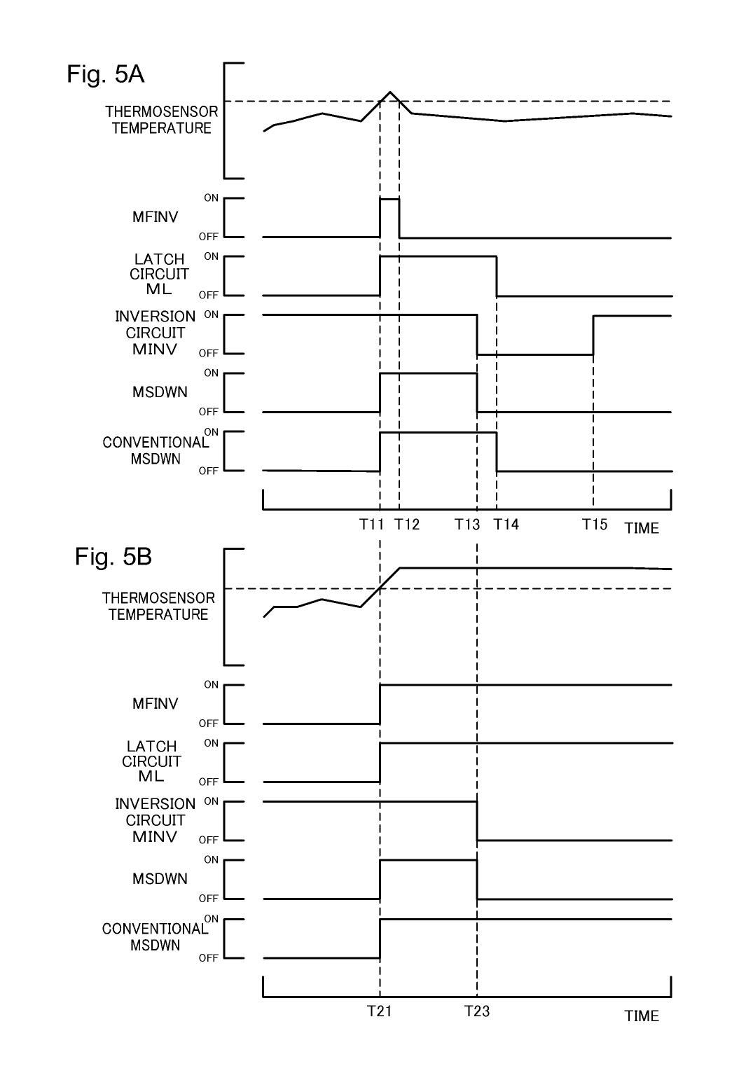

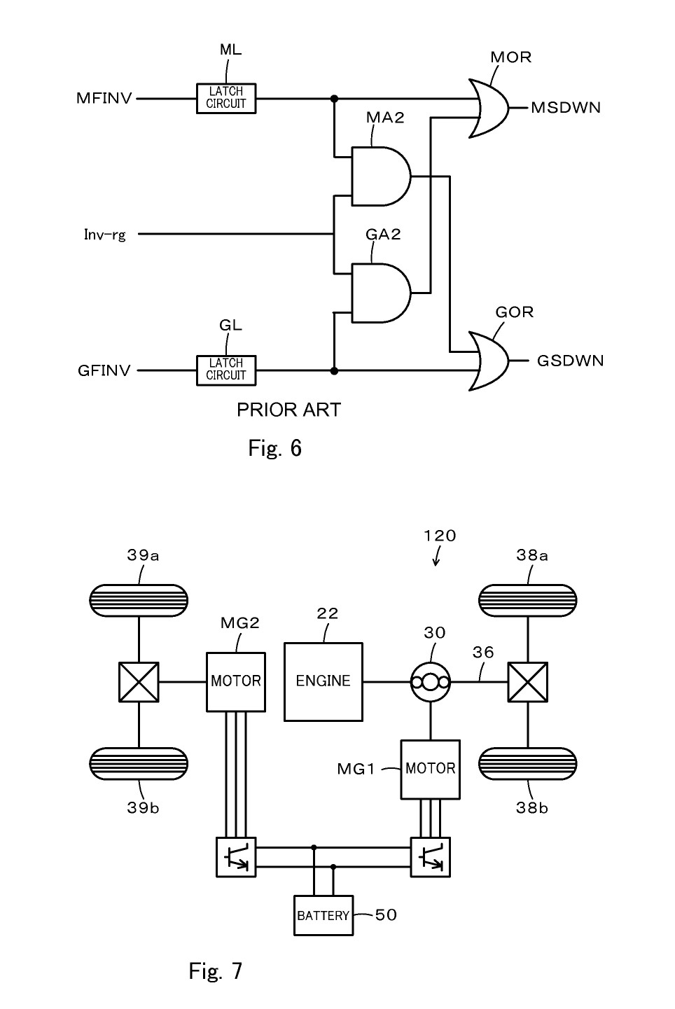

The following describes the operations of the hybrid vehicle 20 according to the embodiment or more specifically the operations in the case where an on-fixation failure occurs in one of the transistors T11 to T16 and T21 to T26 of the inverters 41 and 42. For ease of explanation, it is assumed that an on-fixation failure occurs in the transistor T21 of the inverter 42 for driving the motor MG2 and the signal detected by the thermosensor Sth exceeds the threshold value. FIG. 5A and FIG. 5B show time changes of the temperature of the thermosensor Sth, the fail signal MFINV, the signal from the latch circuit ML, the signal from the inversion circuit MINV, the shutdown signal MSDWN and a conventional shutdown signal MSDWN as a comparative example. FIG. 5A shows the time changes when the temperature of the thermosensor Sth exceeds the threshold value for a short time duration, and FIG. 5B shows the time changes when the thermosensor Sth is broken by overheat and continuously outputs the signal exceeding the threshold value. The conventional shutdown signal MSDWN is a signal output from a prior art abnormal signal conditioning circuit illustrated in FIG. 6.

The prior art abnormal signal conditioning circuit excludes the delay circuits GDL and MDL, the inversion circuits GINV and MINV and the AND gates GA1 and MA1 from the abnormal signal conditioning circuit 60 of the embodiment shown in FIG. 4. In the prior art abnormal signal conditioning circuit, instead of the signals from the AND gates GA1 and MA1, the signals from the latch circuits GL and ML are input into the OR gates GOR and MOR and the AND gates GA2 and MA2.

The on-fixation failure of the transistor T21 causes the overcurrent to flow through the transistor T21 or overheats the transistor T21. The drive circuit DRIC mounted to the transistor T21 accordingly outputs the fail signal FINV as ON signal. The respective fail signals FINV from the transistors T21 to T26 are input into the OR gate (not shown), and the fail signal MFINV is output as the logical sum from the OR gate. Accordingly, the fail signal MFINV is output as ON signal.

In the abnormal signal conditioning circuit 60, when the fail signals GFINV and MFINV are output as OFF signals, OFF signals from the latch circuits GL and ML and ON signals generated by delaying the OFF signals from the latch circuits GL and ML by the delay circuits GDL and MDL and inverting the delayed signals by the inversion circuits GINV and MINV, are input into the AND gates GA1 and MA1, so that the AND gates GA1 and MA1 output OFF signals. Accordingly, the AND gates GA2 and MA2 also output OFF signals, and the OR gates GOR and MOR output the shutdown signals GSDWN and MSDWN as OFF signals. When the fail signal MFINV is output as ON signal (time T11, time T21), on the other hand, ON signal is immediately input via the latch circuit ML to the AND gate MA1. ON signal from the latch circuit ML is delayed by a predetermined adjustment time by the delay circuit MDL, so that the inversion circuit MINV outputs ON signal generated by inverting the OFF signal until elapse of the adjustment time. Accordingly, the AND gate MA1 outputs ON signal, and the OR gate MOR inputting the signal from the AND gate MA1 outputs the shutdown signal MSDWN as ON signal. The ON signal from the AND gate MA1 and the RG signal as ON output are input into the AND gate MA2, so that the AND gate MA2 outputs ON signal and the OR gate GR outputs the shutdown signal GSDWN as ON signal. In the case where an on-fixation failure occurs in one of the transistors T11 to T16 and T21 to T26 of the inverters 41 and 42, the shutdown signal GSDWN or MSDWN is output as ON signal from the abnormal signal conditioning circuit 60.

When overheat is only temporary (instantaneous) and the signal from the thermosensor Sth becomes lower than the threshold value, the fail signal MFINV is output as OFF signal (time T12). As shown in FIG. 5A, the latch circuit ML continuously outputs ON signal until time T14 when the adjustment time has elapsed since time T12. The delay circuit MDL, on the other hand, continuously outputs OFF signal until time T13 when the adjustment time has elapsed since time T11 when the ON signal is output from the latch circuit ML. The inversion circuit MINV thus continuously outputs ON signal. Accordingly, until the time T13, the AND gate MA1 outputs ON signal, and the OR gate MOR outputs the shutdown signal MSDWN as ON signal. At the time T13, the delay circuit MDL outputs ON signal, and the inversion circuit MINV outputs OFF signal. Accordingly, the AND gate MA1 outputs OFF signal, and the OR gate MOR outputs the shutdown signal MSDWN as OFF signal. In the case where the fail signal MFINV temporarily (instantaneously) has ON output, the shutdown signal MSDWN is output as ON signal for the duration of adjustment time from the time T11 to the time T13 and is output as OFF signal after the time T13. In the prior art abnormal signal conditioning circuit, on the other hand, the OR gate MOR outputs the shutdown signal MSDWN as OFF signal at the time T14 when the retention time of the latch circuit ML has elapsed since the time T12 when the fail signal MFINV has OFF output.

When the thermosensor Sth is damaged by overheat to continuously output the signal exceeding the threshold value, the fail signal MFINV is continuously output as ON signal. As shown in FIG. 5B, the latch circuit ML continuously outputs ON signal. At time T23 when the adjustment time of the delay circuit MDL has elapsed since time T21 when the ON signal is output from the latch circuit ML, the delay circuit MDL outputs ON signal, and the inversion circuit MINV outputs OFF signal. Accordingly, the AND gate MA1 outputs OFF signal, and the OR gate MOR outputs the shutdown signal MSDWN as OFF signal. When the fail signal MFINV continuously has ON output, the shutdown signal MSDWN is output as ON signal for the duration of adjustment time from the time T21 to the time T23 and is output as OFF signal after the time T23. In the prior art abnormal signal conditioning circuit, on the other hand, the OR gate MOR continuously outputs the shutdown signal MSDWN as ON signal, along with the continuous ON output of the fail signal MFINV.

When the shutdown signals GSDWN and MSDWN are output as ON signals from the abnormal signal conditioning circuit 60, the motor ECU 40 inputs the shutdown signals GSDWN and MSDWN and shuts down the inverters 41 and 42. On completion of shutdown of the inverters 41 and 42, the motor ECU 40 switches the RG signal having normally ON output to the OFF output. In response to the OFF output of the RG signal, the OFF signal is input into the AND gates GA2 and MA2 of the abnormal signal conditioning circuit 60. In response to the OFF output of the RG signal, the OFF signals is input into the AND gates GA2 and

MA2 of the abnormal signal conditioning circuit 60, so that the AND gates GA2 and MA2 output OFF signals. It is here assumed that the fail signal MFINV is switched to ON signal. ON signal from the AND gate MA1 is input into the OR gate MOR, so that the OR gate MOR outputs the shutdown signal MSDWN as ON signal. OFF signal from the AND gate GA1 is, on the other hand, input into the OR gate GOR, so that the OR gate GOR outputs the shutdown signal GSDWN as OFF signal. This cancels the shutdown of the inverter 41. When the shutdown of the inverter 41 is cancelled, the motor ECU 40 outputs a control signal to the HVECU 70 to perform emergency drive with the engine 22 and the motor MG1 without using the motor MG2. When receiving this control signal, the HVECU 70 performs emergency drive with direct torque, in which the motor MG1 receives a reactive force of the power output from the engine 22 and thereby outputs driving force to the driveshaft 36. In this case, the motor MG2 is dragged.

The shutdown signal MSDWN from the abnormal signal conditioning circuit 60 is switched to OFF signal after elapse of the adjustment time since switching of the fail signal MFINV to ON signal. According to this embodiment, this adjustment time (the predetermined retention time set in the latch circuit ML and the predetermined delay time set in the delay circuit MDL) is set to be longer than a time duration between switching of the fail signal MFINV to ON signal and completion of the shutdown of the inverters 41 and 42 but to be shorter than a time duration between switching of the fail signal MFINV to ON signal and start of emergency drive control (ready for emergency drive control). The adjustment time is set to be longer than the time duration until completion of the shutdown of the inverters 41 and 42, in order to avoid interruption of the shutdown by switching of the shutdown signal MSDWN to OFF signal prior to completion of the shutdown of the inverters 41 and 42. The adjustment time is set to be shorter than the time duration until start of the emergency drive control, in order to avoid the emergency drive control from being not performed due to non-cancellation of the shutdown of the inverters 41 and 42 even after start of the emergency drive control. According to this embodiment, such setting of the adjustment time (the predetermined retention time set in the latch circuit ML and the predetermined delay time set in the delay circuit MDL) causes shutdown of the inverters 41 and 42 and subsequent emergency drive control to be more reliably performed in the event of an on-fixation failure in one of the transistors T11 to T16 and T21 to T26. Accordingly, the emergency drive control is activated to estimate a short-circuit transistor based on the circulating current generated due to a one-phase short circuit fault of the inverter 42 and perform emergency drive with three-phase on-control including the short-circuit transistor. More specifically, in the event of an on-fixation failure of the transistor T21, emergency drive is performed with three-phase on-control that turns on the upper arm of the inverter 42 including this transistor T21. In the prior art abnormal signal conditioning circuit, on the other hand, when the thermosensor Sth is broken, as shown in FIG. 5B, the shutdown signal MSDWN is continuously output as ON signal from the OR gate MOR. This causes neither estimation of a short circuit transistor nor three-phase on-control to be performed during emergency drive.

The foregoing describes the case where an on-fixation failure occurs in the transistor T21 of the inverter 42. The shutdown signals GSDWN and MSDWN are output similarly in the case where an on-fixation failure occurs in any of the transistors T22 to T26 of the inverter 42. In the abnormal signal conditioning circuit 60, the circuit structure involved in the fail signal MFINV is configured symmetrically with the circuit structure involved in the fail signal GFINV. Accordingly, in the case where an on-fixation failure occurs in any of the transistors T11 to T16 of the inverter 41, symmetrical signals are output with those output in the event of an on-fixation failure in the transistor T21 of the inverter 42. More specifically, the shutdown signal MSDWN and the shutdown signal GSDWN are exchanged with each other. Additionally, the foregoing describes the case where an on-fixation failure of the transistor is detected by the thermosensor Sth. This description is similarly applicable to the case where an on-fixation failure of the transistor is detected by the overcurrent.

In the hybrid vehicle 20 of the embodiment described above, in the case where an on-fixation failure occurs in one of the transistors T11 to T16 and T21 to T26 of the inverters 41 and 42, the shutdown signal GSDWN or MSDWN is output as ON signal for the duration of adjustment time after switching of the fail signal GFINV or MFINV to ON signal. The adjustment time during which the shutdown signal GSDWN or MSDWN is output as ON signal is set to be longer than the time duration until completion of the shutdown of the inverters 41 and 42 but to be shorter than the time duration until start of the emergency drive control. This causes shutdown of the inverters 41 and 42 and subsequent emergency drive control to be more reliably performed. Accordingly, the emergency drive control is activated to estimate a short-circuit transistor based on the circulating current generated due to a one-phase short circuit fault of the inverter 42 and perform emergency drive with three-phase on-control including the short-circuit transistor.

In the hybrid vehicle 20 of the embodiment, in the case where an on-fixation failure occurs in one of the transistors T11 to T16 and T21 to T26 of the inverters 41 and 42, the shutdown signal GSDWN or MSDWN is output as ON signal for a predetermined time duration since switching of the fail signal GFINV or MFINV to ON signal . Similarly, in the case where any failure other than the on-fixation failure occurs in one of the transistors T11 to T16 and T21 to T26 of the inverters 41 and 42, the fail signal FINV may be output as ON signal, and the shutdown signal GSDWN or MSDWN may be output as ON signal for a predetermined time duration since switching of the fail signal GFINV or MFINV to ON signal.

In the hybrid vehicle 20 of the embodiment, the abnormal signal conditioning circuit 60 is configured to output the shutdown signal GSDWN or MSDWN as ON signal for the duration of adjustment time since switching of the fail signal GFINV or MFINV to ON signal. One modification may be configured to directly input the fail signals GFINV and MFINV into the motor ECU 40. The shutdown signal GSDWN or MSDWN may be output as

ON signal for the duration of adjustment time since switching of the fail signal GFINV or MFINV to ON signal by the software executed by the motor ECU 40.

In the hybrid vehicle 20 of the embodiment, the power from the motor MG2 is output to the driveshaft 36 linked with the drive wheels 38a and 38b. As illustrated in a hybrid vehicle 120 according to one modification shown in FIG. 7, however, the power from the motor MG2 may be output to another axle (axle linked with wheels 39a and 39b shown in FIG. 7) that is different from an axle connected with the driveshaft 36 (i.e., axle linked with the drive wheels 38a and 38b).

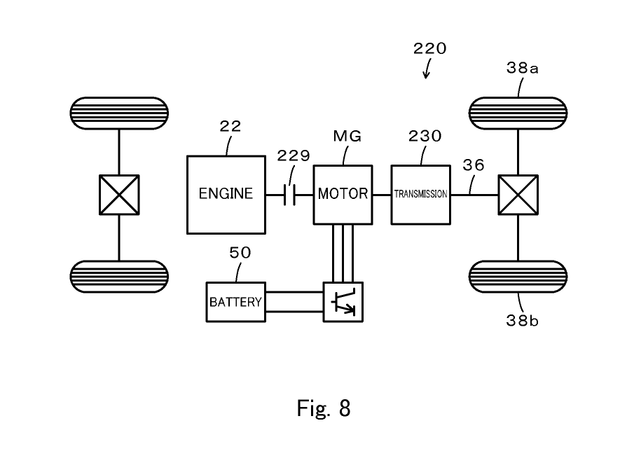

In the hybrid vehicle 20 of the embodiment, the power from the engine 22 is output via the planetary gear 30 to the driveshaft 36 linked with the drive wheels 38a and 38b, while the power from the motor MG2 is output to the driveshaft 36. As illustrated in a hybrid vehicle 220 according to another modification shown in FIG. 8, however, a motor MG may be connected via a transmission 230 with the driveshaft 36 that is linked with the drive wheels 38a and 38b, and an engine 22 may be connected via a clutch 229 with a rotating shaft of the motor MG. The power from the engine 22 may be output to the driveshaft 36 via the rotating shaft of the motor MG and the transmission 230, while the power from the motor MG may be output to the driveshaft 36 via the transmission 230. In other words, the invention may be applicable to any configuration that has a motor mechanically linked with an axle and has a power source other than the motor to output power for running.

In the motor vehicle of the above aspect, the abnormal signal conditioner may include a latch circuit that is configured to latch the switched-on abnormal signal for the predetermined time period and output a latched signal; a delay inversion circuit that is configured to delay and invert the signal from the latch circuit for the predetermined time and output a delayed and inverted signal; and an AND circuit that is configured to input the signal from the latch circuit and the signal from the delay inversion circuit and output a logical product as the shutdown abnormal signal.

In the motor vehicle of the above aspect, the predetermined time period may be set to be longer than a time duration between switching the shutdown abnormal signal on and completion of shutdown of the inverter by the shutdown controller but to be shorter than a time duration between switching the shutdown abnormal signal on and start of emergency drive control triggered by switching the abnormal signal on. Setting the predetermined time period to be longer than the time duration until completion of shutdown of the inverter avoids interruption of shutdown by switching the shutdown abnormal signal off prior to completion of shutdown of the inverter. Setting the predetermined time period to be shorter than the time duration until start of emergency drive control, on the other hand, avoids emergency drive control from being not performed due to non-cancellation of shutdown of the inverter even after a start of emergency drive control.

The motor vehicle of the above aspect may comprise an internal combustion engine as the power source, a generator and a planetary gear mechanism configured such that three rotational elements are respectively connected with an output shaft of the internal combustion engine, the generator and a driveshaft linked with an axle. The motor may be mechanically connected with the driveshaft.

The aspect of the invention is described above with reference to the embodiment. The invention is, however, not limited to the above embodiment but various modifications and variations may be made to the embodiment without departing from the scope of the invention.

### INDUSTRIAL APPLICABILITY

The present invention is applicable to, for example, manufacturing industries of motor vehicles.

1. A motor vehicle, comprising
a power source that is configured to output power to an axle;
a motor that is mechanically linked with the axle;
an inverter that is configured to have a plurality of switching elements and drive the motor;
an abnormal signal generator that is configured to switch an abnormal signal on in the case where a fault occurs in any of the plurality of switching elements;
a shutdown controller that is configured to shut down the inverter when a shutdown abnormal signal is switched on, based on switching the abnormal signal on; and
an abnormal signal conditioner that is configured to, in response to switching the abnormal signal on, keep the shutdown abnormal signal on for a predetermined time period and subsequently switch the shutdown abnormal signal off, irrespective of a time duration when the abnormal signal is kept on.

2. The motor vehicle according to claim 1,
wherein the abnormal signal conditioner comprises
a latch circuit that is configured to latch the switched-on abnormal signal for the predetermined time period and output a latched signal;
a delay inversion circuit that is configured to delay and invert the signal from the latch circuit for the predetermined time and output a delayed and inverted signal; and
an AND circuit that is configured to input the signal from the latch circuit and the signal from the delay inversion circuit and output a logical product as the shutdown abnormal signal.

3. The motor vehicle according to claim 1,
wherein the predetermined time period is set to be longer than a time duration between switching the shutdown abnormal signal on and completion of shutdown of the inverter by the shutdown controller but to be shorter than a time duration between switching the shutdown abnormal signal on and start of emergency drive control triggered by switching the abnormal signal on.

4. The motor vehicle according to claim 2,
wherein the predetermined time period is set to be longer than a time duration between switching the shutdown abnormal signal on and completion of shutdown of the inverter by the shutdown controller but to be shorter than a time duration between switching the shutdown abnormal signal on and start of emergency drive control triggered by switching the abnormal signal on.
